(19) United States
(12) Patent Application Publication
(10) Pub. No.: US 2013/0076021 A1
(43) Pub. Date: Mar. 28, 2013

(54) Structured tee with wear pocket

(71) Applicant: David E. Sisk, Bonne Terre, MO (US)

(72) Inventor: David E. Sisk, Bonne Terre, MO (US)

(21) Appl. No.: 13/200,625

(22) Filed: Sep. 27, 2011

(51) Int. Cl. F16L 41/00

(52) U.S. Cl. 285/133.5

(57) ABSTRACT

A hopper tee having a horizontal portion through which granular material is unloaded from a tank trailer or hopper car, the hopper tee integrally forms a vertical segment, that secures with the bottom of the hopper, to provide for unloading of granular material for usage or storage. The upper front portion of the tee, as it transitions from its vertical segment to the horizontal flow path has secured or cast therewith a ledge, that provides for accumulation of the unloading granular material therein, to function as a wear pad to resist against abrasion, and accelerated wear out, of the tee, at that location, during prolonged usage.

### CROSS REFERENCE TO RELATED APPLICATION

This provisional patent application claims priority to the non-provisional patent application having Ser. No. 12/249,672, having filing date Oct. 10, 2008, and which claims priority to the provisional patent application having Ser. No. 61/030,777, having filing date Feb. 22, 2008.

### FIELD OF THE INVENTION

This invention relates to an improved means for conveyance of granular material, and more specifically pertains to a tee device that connects to the bottom of a hopper of a tank trailer, or other vehicle, and which has reinforcement that resist against wear through abrasion.

### BACKGROUND OF THE INVENTION

This invention relates generally to hopper tees, as used in bulk material handling, and more specifically pertains to a hopper tee that is reinforced to provide a padding to resist against abrasion and premature wear to the tee at those locations were granular material excessively impinges against during unloading of a tank trailer, hopper car, or the like.

Hoppers, or tank trailers, regularly transport bulk commodities such as industrial and food products, and even such abrasive materials such as sand, or other pelletized materials. When the hopper, or tank trailer, reaches its destination, the bulk commodity is unloaded, typically by a power takeoff driven from a truck mounted blower or a pneumatic system of a plant or factory. The bulk commodity generally unloads from the hopper and into a pipeline. To complete the unloading, hopper tees are mounted to the discharge outlet of the hoppers, or bins, the hopper tee conventionally has a vertical section of constant dimension and shape and a horizontal section also of consistent dimension and shape forming the inverted tee shape configuration. To transfer the bulk commodity, the materials move out of the hopper, or bin, by gravity flow or air pressure vibration into the vertical section of the hopper tee. The discharge pipe is connected to the horizontal section of the tee. Pneumatic conveyance of the bulk material through the pipe occurs by establishing a pressure differential in the pipe. Usually, the prior art hopper tees have a complete, one piece assembly that includes a vertical section, connecting to a hopper, and a horizontal section, connecting to a discharge pipe. The prior art hopper tee design fits on the bottom of the bins of pneumatic tank trailers. Typically, the butterfly valve of the bin bolts to the flange of the hopper tee. Although, prior art hopper tees function well for their intended purposes, some tees are structured where the granular material being unloaded will impinge upon specific surfaces of the tee, under pressure, and has a tendency to cause abrasion, if not eventual wear through of the tee at these active locations of the tee structure.

### DESCRIPTION OF THE PRIOR ART

A variety of patents have issued upon various devices to ease the transfer and unloading of bulk granular ingredients from a hopper or bin into a discharge line for delivery to a plant or factory. Prior art hopper tees have a construction of a vertical pipe welding to horizontal pipe in a generally tee shape. Or, such tees may be cast in their integral shape and structure. These tees remain subject to excessive internal wear by the friction of the bulk material and eventually fail as they wear away. Previously, the applicant had addressed such wear problems. The U.S. Pat. No. 4,848,396, to Sisk, discloses a Cast Hopper Tee designed to provide a smooth and uninterrupted internal transitional surface. That patent also provided for such an improvement in a bottom drop hopper tee.

The U.S. patent to Campbell, et al, U.S. Pat. No. 6,582,160, provides a hopper tee and integral discharge valve. This hopper tee has an inlet that connects to a hopper discharge opening and a perpendicular second hollow pipe section. The inlet has a cylindrical sidewall, and the hollow pipe section also has a cylindrical cross section, that shows an interior tapering of the inlet and the second hollow pipe section.

The U.S. patent to Kraenzle, U.S. Pat. No. 7,568,496, shows a dual flange tee. This tee also shows upper and lower pipe sections, which form the structure of the tee.

U.S. Pat. No. 5,387,015, to Sisk, the inventor herein, is a single piece Hopper Tee with an elliptically shaped opening within the neck. Generally a first pipe in the flange joins perpendicularly to an edge of the second pipe that then connects to the pipeline tubing.

A design patent to Sisk, U.S. No. D376,416, shows the physical appearance and ornamentation of a Directional Flow Structural Tee.

Another patent to Sisk, U.S. Pat. No. 5,676,404 shows a Low Profile Flanged Tee akin to the Kraenzle structure referred to above. This patent shows a tee with a diameter of the hollow pipe section increases proximate the opening to the discharge hopper.

The U.S. Pat. No. 5,842,681, to Sisk, describes a Pivotal Hopper Tee with Alignable Swing-Away Hopper Tee Assembly. This hopper tee has a mounting frame that connects to the hopper discharge and a camming handle with a hook that swings upon its pivot arms.

Another U.S. Pat. No. 6,786,362, to Sisk, is similar to the '681 patent. This is a Swing-Away Hopper Tee that has a mounting frame that connects to the tee assembly.

The prior art discloses various hopper tees, with a flat door, large wings extending coplanar with the door, or the drop portion of the tee, as to be noted. Over time, with rugged usage, and subject to environmental factors, portions of the tees can be abrasively diminished in thickness, particularly at that location where the vertical portion of the tee transitions into the forwardly extending horizontal portion of the tee, with the abrasive material both dropping from the proximate hopper can impinge upon its surface, particularly when the tee may be downstream from a series of other tees that are unloading similar granular material, and the granular materials are thrust against that transitional surface of the tee continuously until unloaded.

### SUMMARY OF THE INVENTION

This invention provides a hopper tee with an internally reinforced portion that provides essentially a ledge that creates a collection area, where a pad of the granular material being unloaded can collect, and function just that, as a wear pad that guards against direct contact of the moving granular material against the internal surface of the cast tee, at that transitional area between the neck of the tee, and its horizontal conveying portion, to resist against premature wear and abrasion of the tee at that location, thereby enhancing its useful life. Furthermore, it prevents any contamination from entering into the unloaded material, which is a necessity particularly where food product may be conveyed, such as grains, other granular food product, polymer pellets that are useful for molding food containers, and the like.

Essentially this invention contemplates the formation of additional structure within a cast hopper tee, and which can function to provide for accumulation of the unloading granular material thereat, to essentially accumulate a bulk of such material at that location where impingement of the granular material against the internal structure of tee most likely occurs, and therefore, uses the same granular material to resist against abrasion of the tee, and thereby avoid the problems as previously described.

As a real example of the type of granular materials that may cause wear, eventually, within a tee, particularly at the upper portion were it transitions from its vertical part to its horizontal portion, sand, such as industrial sand, that may be utilized within a chemical operation, or in some other plant processing, may be the type of granular material that is conveyed by the tank trailer to the site of its usage. When that is the case, sand is highly abrasive, and does have a tendency to wear out these industrial tees, that are principally used in the unloading of such materials from a tank trailer, or the like. Thus, providing for reinforcement in the manner of this current invention not only utilizes the unloading material itself as a wear pad, but substantially reduces the abrasive effect that causes an eventual wear out of the tee, when used over a period of time.

The structure of the tee is generally formed in the manner as previously known in the art, includes a longitudinal portion through which the material generally flows, and this portion of the tee normally incorporates some type of a bell portion, that allows for its interconnection with the pipeline that conveys the pressurized air, through the unloading pipe, drawing the granular material from the various hoppers, through their tees, and conveying such material for storage or use at a distant location. Such tees, as know in the art, also include a vertical section, that is integrally cast or formed with the unitary tee, and normally includes curvature at its forward portion, to provide for a smoother transition of the bulk material, as it descends from the hopper, through the vertical part of the tee, and is picked up by the conveying air pressure within the horizontal section of the tee, and its interconnected pipeline, for transit during unloading.

As previously commented, that curved portion of the tee between its vertical and horizontal sections, at their frontal area, has a tendency to have the bulk material thrust against it, continuously, during the unloading process, and which functions to generate abrasiveness that can eventually wear upon the metallic structure of the tee, to the extent where it eventually will wear thin, if not wear all the way through, making the tee useless and requiring its replacement. To solve this problem, the current invention integrates or connects a ledge like member, that is generally arranged tangent to the outlet portion of the horizontal section of the tee, so that material may accumulate above the ledge and create a surface or wear pad that protects that integral arcuate portion of the tee against impingement thereagainst of the granular material being unloaded, and therefore functions, as explained, as a wear pad against premature or routine deterioration. Such a ledge can be cast integrally within the structure of the tee, and this is regardless whether the tee, as normally, is cast of iron or metal, and such a structure could even be used in tees that are formed of hardened polymer, and which may be used similarly, for transfer of other types of granular material, during their unloading. The ledge can be either cast in place, or welded internally of the tee, in order to form that compartment that is readily disposed for collection of the unloading material, promptly, as the granular material is initially being unloaded, in order to furnish that wear pad that sustains throughout the entire unloading procedure, and until all the granular material has been removed. The shape and configuration of the ledge, particularly at its front edge, can be to that shape which desirably forms the material pad as described, while the peripheral edges of the ledge will undertake those contours that allows for it to mate internally with the tee, at the location where the ledge internally contacts the interior surface of the tee, so that it can be welded in place, if not cast in place.

It is, therefore, the principal object of this invention to provide means for furnishing a wear pad of granular material being unloaded through a hopper tee, so as to resist against abrasion to the proximate surface of the internal part of the tee where the pad is formed.

Another object of this invention is to provide means for accumulating a wear pad of unloading granular material and which, when formed, undertakes a contour that further aids in the transition of the granular material from the hopper, through the tee, and into the outlet line, during its unloading.

Another object of this invention is to provide an integral hopper tee where a ledge can be cast in situ during the casting of the tee into its usable configuration.

Still another object of this invention is to provide a tee that facilitates the removal of granular material from a tank trailer, which greatly lengthens its useful life, without detracting from the uniformity of removal of material during its unloading.

Still another object of this invention is to provide a ledge that is tangentially cast or welded to the vertical part of the hopper tee, and generally inline with the upper apex of the horizontal or outlet portion of the tee in its structural assembly.

These and other objects may become more apparent to those skilled in the art upon review of the invention as provided herein, and upon undertaking a study of description of its preferred embodiment, in view of the drawings.

### BRIEF DESCRIPTION OF THE DRAWINGS

In referring to the drawings,

FIG. 1 is a longitudinal sectional view through the hopper tee of this invention, showing the location of its integral ledge that forms a pocket in which product may accumulate and furnish a pad surface that resists against wear of the tee at that location;

FIG. 1A is a top view of the tee with wear pocket;

FIG. 1B is a sectional end view showing the location of the ledge being applied tangentially to the upper apex of the horizontal portion of the formed tee;

FIG. 2 is a longitudinal sectional view of a similar type tee, of the type that incorporates a bottom drop;

FIG. 2A is a top view of the tee with wear pocket;

FIG. 2B is a transverse sectional view through the tee showing the location of its integral ledge provided within the vertical portion of the formed tee;

FIG. 3 is a schematic of the material flow dropping down through the tee, filling the wear pocket as noted, and being picked up by the material flow passing through the outlet line and the horizontal portion of the tee during product unloading; and

FIG. 4 discloses how material flow through the horizontal portion of the tee will have a tendency to slightly elevate at the location of its vertical conduit and therefore can bias unloading material against the curved portion of the tee, but which forms the wear pad of such material as can be noted.

### DESCRIPTION OF THE PREFERRED EMBODIMENT

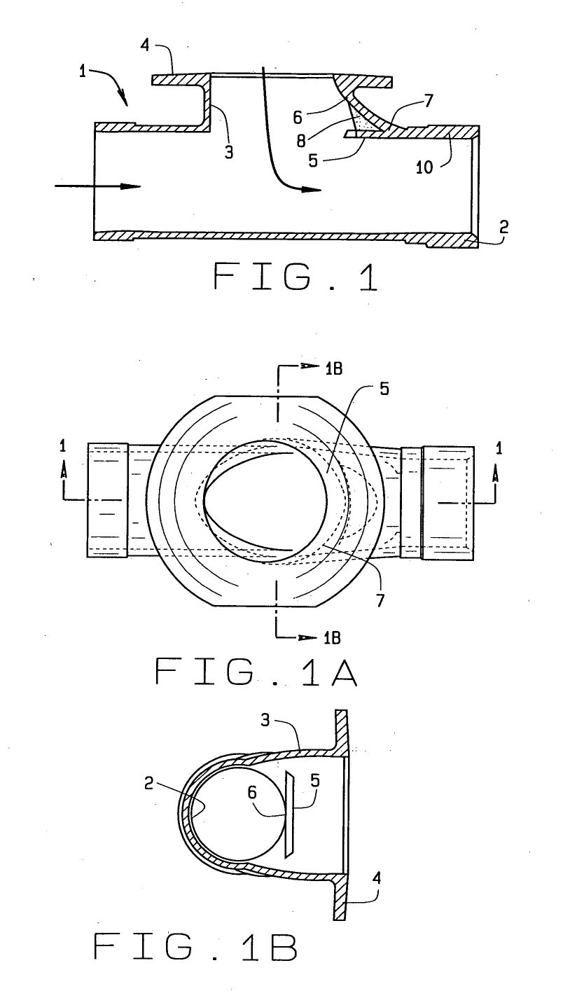

In referring to the drawings, and in particular FIG. 1, therein can be seen the hopper tee 1 that incorporates its horizontal longitudinal section 2 which is essentially a horizontal conduit through which the bulk material flows, as it is being moved by air pressure through the outlet line (not shown) that connects with both ends of the tee, as can be understood. The vertical section of the tee 3 is usually integrally cast when the tee is formed, and includes an outwardly extending flange portion 4 which includes a series of apertures and allows for the tee to be connected to the bottom of the hopper bin, to be unloaded, or to a butterfly valve, or a swing-away type of valve, as known in the art.

The essence of the current invention is the application of a ledge, as at 5, to the upper front portion of the tee, and this ledge can be integrally cast in place, or it can be welded in situ, as the tee is being formed.

As previously explained, the upper front portion of the tee, as at 6, includes a curved portion, and this is to help facilitate the downwardly flow of the unloading granular material, and its shift forwardly by the air pressure passing through the horizontal portion of the tee, so that the bulk material is thrust forwardly, during its movement, with least resistance. But, as previously explained, where more abrasive type of material is being unloaded, that material is thrust against that curved portion 6 of the tee, as it drops and is moved forwardly, and acts as a abrasive against that part of the tee, which can through resistance eventually wear out, if not wear through, the tee at that location. This leads to accelerated deterioration of the tee, and its need for replacement. This type of abrasion frequently occurs where abrasive type material is being unloaded, whether it be industrial granular material, such as sand, or industrial type sand that may be used in chemical operations, or even some granular type food products that are conveyed by tank trailers, or hopper cars, and which are unloaded in a similar fashion, through a series of inline tees, and the outlet pipes, subject to the pressurized airflow.

The ledge 5 as noted and as can be seen in FIGS. 1A and 1B, may undertake an arcuate type shape, and it is either cast along the interior walls of the vertical portion of the tee, where it transitions into the horizontal portion, generally at that location as noted at 7. As noted, the ledge is of relatively shallow shape, but is sufficient to allow for the accumulation of the granular material between its upper surface, and the inner arcuate portion of the front of the tee, as at 6, with the accumulated product or granular material being shown at 8 and therein functioning as a formed wear pad, against which other granular material being unloaded will impinge, so that the granular material as it flows does not rub against the interior arcuate section 6 of the pipe, but rather, acts or biases against the formed wear pad 8, as can be noted. Thus, abrasion does not occur to the tee because the unloading granular material or product does not rub against the internal surface of the tee, at that location, but rather, biases against its own product, as can be seen.

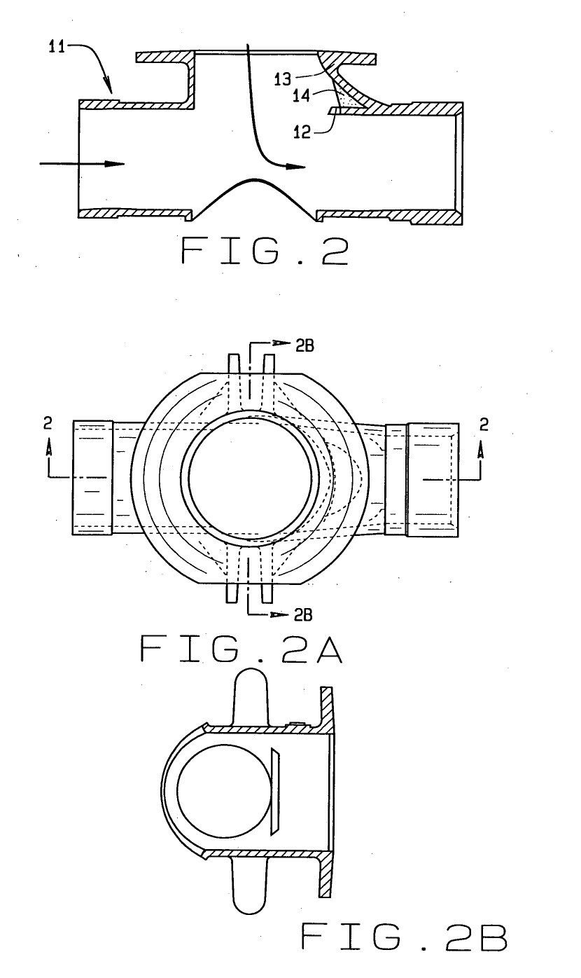

As can be seen in FIGS. 2A and 2B, the ledge 5 either will be integrally cast within the tee forming that pocket surface along the interior of the tee, at that location, or the ledge 5 may be independently formed, if casting is difficult, and then welded into position to form its noted ledge, in the manner as shown and described for its usage with respect to FIG. 1.

As also noted in FIG. 1 B, the ledge 5 is generally arranged and formed tangentially with the upper surface 9 of the horizontal pipe 2, and it mates essentially all away around the circumference, from side to side, at that region of the juncture between the arcuate portion 6 of the vertical section of the tee, as it transitions into the upper horizontal wall 10 of the tee, as can be noted.

FIGS. 2, 2A, and 2B, show a similar type construction for the formed tee 11 and its ledge 12 also as either integrally cast or welded in place, to the vertical arcuate section 13 of the formed tee, similar to that for the structured tee as previously described with regard to FIG. 1. In this instance, this is a bottom drop tee, as known in the art, otherwise the structure of the tee is similar to that as previously described, and which incorporates the sand wear pocket 14 which fills up with the sand or other granular material being unloaded, to form that shown wear pad, to substantially reduce the abrasive wear that occurs at that location of the tee, as the granular material is being unloaded.

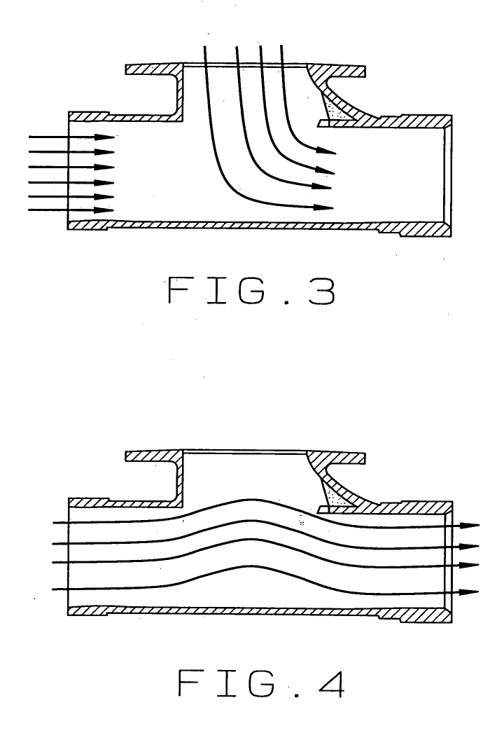

FIG. 3 shows how the material flow dropping from the bin of a tank trailer falls downwardly and is entrained within the material flow passing through the horizontal portion of the same tee, filling the ledge and wear pad provided therein, to achieve the benefits and results of this: invention, which is to minimize wear of the arcuate portion of the tee at the location of said pad.

FIG. 4 provides a schematic to show how material flowing through a tee, along the outlet line, has a tendency to rise up against the internal arcuate portion of the tee, to fill in above its ledge and to form a wear pad to resist against premature abrasion.

That portion of the tee where it transitions between its vertical section to its horizontal section, and as previously described as a curved portion 6, in actuality, is a contoured part that may be formed as arcuate, or convexed, as shown at 6, or it may be slightly concaved, or it may be simply a flat surface that transitions between the vertical to the horizontal part of the tee at that location. Any one of these shapes can comprise the contour for the tee where it transitions from its vertical section to the horizontal section in order to facilitate its unloading of the granular material.

Variations or modifications to the subject matter of this invention may occur to those skilled in the art upon review of the disclosure as provided herein. Such variations, if within the spirit of this invention, are intended to be encompassed within the scope of any claims to patent protection issuing herein. The description of the preferred embodiment of this invention, and its disclosure in the drawings, are set forth for illustrative purposes only.

1. A structured hopper tee with a wear pocket, provided to resist abrasion within the hopper tee during an unloading process, the hopper tee structure having a horizontal section through which the granular material, is unloaded through an outlet pipe, said tee having a vertical section into which the granular material drops from a tank trailer or hopper into the tee during its unloading, the upper front section of the tee having a contour to transition from the vertical section of the tee to the horizontal section of the tee to facilitate the unloading of its granular material, a ledge formed at the bottom of the upper front vertical section of the tee, where it transitions into the horizontal section, and said ledge provided for accumulation of granular material to form a wear pad against which the granular material impinges as it is being unloaded and thereby prevents direct exposure of the internal surfaces of the tee, at that location, with the passing granular material in order to resist and reduce any abrasion or wearout of the tee at that location.

2. The structured hopper tee with wear pocket of claim 1, wherein said ledge is cast in place internally of the formed tee.

3. The structured hopper tee with wear pocket of claim 1 wherein said ledge is design cut and welded in place within the interior of the structured tee.

4. The structured tee with wear pocket of claim 1 wherein said ledge is formed of an edge configuration, and transitions integrally into the interior walls of the tee at the location where its vertical section integrally transitions into the horizontal section of the tee at that location.

5. The structured tee with wear pocket of claim 1 wherein said ledge, at its edge, is formed of an arcuate configuration.

6. The structured tee with wear pocket of claim 4 wherein said contour that transitions between the vertical section of the tee to the horizontal section of the tee is of a convex configuration.

7. The structured tee with wear pocket of claim 4 wherein that contour to transition from the vertical section of the tee to the horizontal section of the tee is of a concave configuration.

8. The structured tee with wear pocket of claim 4 wherein said contour that transitions from the vertical section of the tee to the horizontal section of the tee is of an approximate flattened shape.

9. The structured tee with wear pocket of claim 4 wherein said edge of the ledge is of a straight configuration.
